(19) United States
(12) Patent Application Publication
(10) Pub. No.: US 2019/0387125 A1
(43) Pub. Date: Dec. 19, 2019

(54) SYSTEMS AND METHODS FOR SCANNING PAYMENT AND LOYALTY CARDS AS A SERVICE

(71) Applicant: GroupGifting.com, Inc., Huntington, NY (US)

(72) Inventors: Eric Charles Manno, Centereach, NY (US); David Scott Levinsky, Huntington Station, NY (US); Mark James Manno, Dix Hills, NY (US); Tyler Roye, Huntington, NY (US)

(21) Appl. No.: 16/245,905

(22) Filed: Jan. 11, 2019

Related U.S. Application Data
(63) Continuation of application No. 14/686,204, filed on Apr. 14, 2015, now abandoned.
(60) Provisional application No. 61/979,110, filed on Apr. 14, 2014.

(51) Int. Cl. H04N 1/34

(52) U.S. Cl. CPC H04N 1/34

(57) ABSTRACT

The systems and methods of the present disclosure enable a scanner cloud server to control a mobile device to scan a payment or loyalty card and to convert the scanned card into an electronic card. This is accomplished through the use of a scanner cloud interface that is incorporated into a mobile application installed on the mobile device. The scanner cloud server receives a request for scanning a card from the mobile application via the scanner cloud interface, and sends a request to the mobile application via the scanner cloud interface to scan a card using a scanning device, such as a camera, of the mobile device. The scanner cloud interface connects to the scanning device using the authorizations granted to the mobile application and controls the scanning device to scan the card to obtain an image of the card. The mobile application transmits the image to the scanner cloud server, which recognizes information in the image and generates an electronic card based on the recognized information. The mobile application displays the electronic card when it is received from the scanner cloud server via the scanner cloud interface in response to a user's request to display the electronic card.

### CROSS-REFERENCE TO RELATED APPLICATIONS

The present application is a continuation of U.S. patent application Ser. No. 14/686,204, filed Apr. 14, 2015, which claims priority to and the benefit of U.S. Provisional Application No. 61/979,110, filed Apr. 14, 2014. The entire contents of each of the foregoing applications are hereby incorporated by reference herein.

### BACKGROUND

### Technical Field

The present disclosure relates to cloud services for scanning payment and loyalty cards. More particularly, the present disclosure relates to systems and methods for providing cloud services for scanning payment and loyalty cards to mobile devices via a scanner cloud interface of a mobile application installed on the mobile devices.

### Background of Related Art

The distribution of loyalty cards and the sales of payment cards, such as gift cards, by retailers, have recently been on the rise because of the flexibility offered to recipients of these cards. For example, gift givers often spend a significant amount of time finding the right gift to give to friends or family members. And gift recipients may want to exchange their gift for another item which is better suited for the gift recipient's needs or preferences. Gift cards, however, relieve the burden on gift givers to find the right gift and relieve the burden on gift recipients to return and replace their gift.

Many retailers create and maintain mobile applications to promote sales of their products. Through these mobile applications, retailers send consumers coupons, notify consumers that they are close to a retailer's store, show advertisements, etc. to promote sales of their products. Many retailers also sell electronic payment cards so that consumers do not have to carry a physical payment card and use it to buy a retailer's products. Many mobile applications for retailers allow consumers to buy electronic payment cards and use them to purchase the retailers' products.

As to physical payment cards, consumers often forget to use them for a substantial amount of time or even lose them. When a predetermined amount of time elapses, the money in the physical payment cards may be transferred to the government under escheat or abandoned property laws. Thus, the retailer loses the opportunity for a sale of its products and the consumer loses the opportunity to purchase a product. Many retailers would like to convert physical payment cards to electronic payment cards but lack the resources, e.g., time, money, and/or expertise, to develop a mobile application that performs such a conversion.

### SUMMARY

The scanner cloud system and corresponding methods of the present disclosure enable a scanner cloud server to control a mobile device to scan a payment or loyalty card. This is accomplished through the use of a scanner cloud interface that is incorporated into a mobile application installed on the mobile device and that uses the authorization information granted by users of the mobile application to control scanning devices and other devices of the mobile device. A scanner cloud software development kit is provided to mobile application developers so that they can incorporate the scanner cloud interface into the retailers' mobile applications and thereby easily incorporate physical payment or loyalty card scanning features.

In one aspect, the present disclosure features a method performed by a scanner cloud server to provide a scanning service through a network to a mobile application, which is installed on a mobile device and which incorporates a scanner cloud interface. The method includes receiving a request for scanning a card from the mobile application via the scanner cloud interface, sending a request to make a connection between a scanning device of the mobile device and the scanner cloud interface using the authorizations granted to the mobile application, controlling the scanning device to scan the card to obtain an image, and receiving the image of the scanned card from the mobile application via the scanner cloud interface.

The method may include optically recognizing information in the image of the scanned card, and storing the recognized information. The method may include generating an electronic card based on the optically recognized information, and transmitting the electronic card to the mobile application via the scanner cloud interface in response to a request for the electronic card from the mobile application.

The method may include receiving information input by a user from the mobile application via the scanner interface, and generating the electronic card based on the optically recognized information and the information input by the user. The method may include transmitting at least one of the recognized information and the information input by the user to the mobile application via the scanner cloud interface in response to a request from the mobile application to edit at least one of the recognized information and the information input by the user.

The method may include receiving new information input by a user from the mobile application via the scanner cloud interface, and updating at least one of the recognized information and information previously input by the user with the new information. The method may include receiving information input by a user from the mobile application via the scanner interface, and generating an electronic card based on the information input by the user.

In another aspect, the present disclosure features a method performed by a mobile device on which a mobile application is installed. The mobile application incorporates a scanner cloud interface for communicating with a scanner cloud server. The method includes activating the scanner cloud interface upon user selection of the scanner cloud interface in the mobile application, detecting user selection of a scanning option in the mobile application to scan a card, transmitting a message that the user has selected the scanning option to the scanner cloud server via the cloud scanner interface, receiving commands from the scanner cloud server via the scanner cloud interface to scan the card, scanning the card to obtain an image of the card, and transmitting the image of the scanned card to the scanner cloud server via the scanner cloud interface.

The method may include prompting the user to select an option of the scanner cloud interface, detecting selection by the user of a display option for displaying the electronic card, prompting the user to select an electronic card, detecting selection by the user of an electronic card, sending a request for the electronic card to the scanner cloud server via the scanner cloud interface, receiving the electronic card from the scanner cloud server via the scanner cloud interface, and displaying the electronic card.

Receiving the electronic card may include receiving graphical images and data, and displaying the electronic card may include assembling the graphical images and data into an electronic card image.

The method may include prompting the user to select an option of the scanner cloud interface, and determining whether a manual update option or a manual entry option is selected. When it is determined that the manual update option is selected, the method may include prompting the user to select an electronic card, detecting selection by the user of an electronic card, transmitting a request for information relating to the electronic card to the scanner cloud server via the scanner cloud interface, receiving information relating to the electronic card from the scanner cloud server via the scanner cloud interface, displaying an update screen allowing the user to update the information relating to the electronic card, and transmitting updated information to the scanner cloud server via the scanner cloud interface.

When it is determined that the manual entry option is selected, the method may include prompting the user to enter information relating to a payment or loyalty card, and transmitting information entered by a user to the scanner cloud server via the scanner cloud interface.

The information entered by the user may be related to a barcode, a QR code, or may be information which is shown or not shown on a payment or loyalty card.

The method for controlling the mobile device may include determining whether the scanner cloud interface is in communication with the scanner cloud server. The method may also include receiving an electronic card from the scanner cloud server via the scanner cloud interface, storing the electronic card in memory of the mobile device, and retrieving the electronic card from the memory, when the user requests the electronic card and it is determined that the scanner cloud interface is not in communication with the scanner cloud server. The method may include storing the image of the scanned card in memory of the mobile device, when it is determined that the scanner cloud interface is not in communication with the scanner cloud server, and transmitting the stored image to the scanner cloud server, when it is determined that the scanner cloud interface is in communication with the scanner cloud server.

In yet another aspect, the present disclosure features a scanner cloud server that provides scanning as a service through a network to a mobile application of a mobile device. The scanner cloud server includes a scanner cloud engine interface that communicates with the mobile application via a scanner cloud interface of the mobile application to control the scanning device on the mobile device to scan a card to obtain an image, a recognition module that recognizes information in the image of the scanned card, an input module that receives information input by a user from the mobile application via the scanner cloud interface, and a storage device that stores at least one of the image, the recognized information, and the input information, and an image display module that generates an electronic card based on at least one of the recognized information and the input information, and transmits the electronic card to the mobile application via the scanner cloud interface in response to a request to display the electronic card received from the mobile application via the scanner cloud interface.

The input module may update at least one of the recognized information and the input information previously received from the mobile application with new input information received from the mobile application. The scanner cloud engine interface may control or manage resources of the mobile device by communicating with the mobile application via the scanner cloud interface.

### BRIEF DESCRIPTION OF THE DRAWINGS

The present disclosure may be understood by reference to the accompanying drawings, when considered in conjunction with the subsequent, detailed description, in which:

FIG. 1 is a block diagram of a system in which a mobile application is developed for implementing scanner-as-a-service functionality, in accordance with embodiments of the present disclosure;

FIG. 2 is a block diagram of a scanner cloud system in accordance with embodiments of the present disclosure;

FIG. 3 is a block diagram of the mobile device of FIG. 1;

FIG. 4 is a block diagram illustrating a scanner cloud system for providing scanning as a service in accordance with embodiments of the present disclosure;

FIG. 5 is a flowchart illustrating a process performed by a mobile device in accordance with an embodiment of the present disclosure;

FIG. 6A is a flowchart illustrating processes performed by a mobile device in response to scan and display options selected by a user in the process of FIG. 5;

FIG. 6B is a flowchart illustrating further processes performed by a mobile device in response to manual entry and manual edit options selected by a user in the process of FIG. 5;

FIG. 7 is a flowchart illustrating a process performed by a scanner cloud server in accordance with an embodiment of the present disclosure;

FIG. 8A is a flowchart illustrating processes performed by a scanner cloud server based on scan and display options selected by a user;

FIG. 8B is a flowchart illustrating further processes performed by a scanner cloud server based on manual entry and manual edit options selected by a user; and

FIG. 9 is a flowchart illustrating a process performed by a mobile device in accordance with an embodiment of the present disclosure.

### DETAILED DESCRIPTION

A scanner cloud system according to the present disclosure enables mobile applications of retailers to scan physical cards, e.g., capture images of physical payment or loyalty cards using a camera of a mobile device, and to convert these physical cards into electronic cards. The mobile applications incorporate a scanner cloud interface through which a scanner cloud server can control components of the mobile device to scan the physical card and convert the scanned physical card into an electronic card. For example, the scanner cloud server can control, via the scanner cloud interface, the mobile device to capture an image of a physical card using a camera of the mobile device and to transmit the image of the physical card to the scanner cloud server for further processing to convert the physical card into an electronic card.

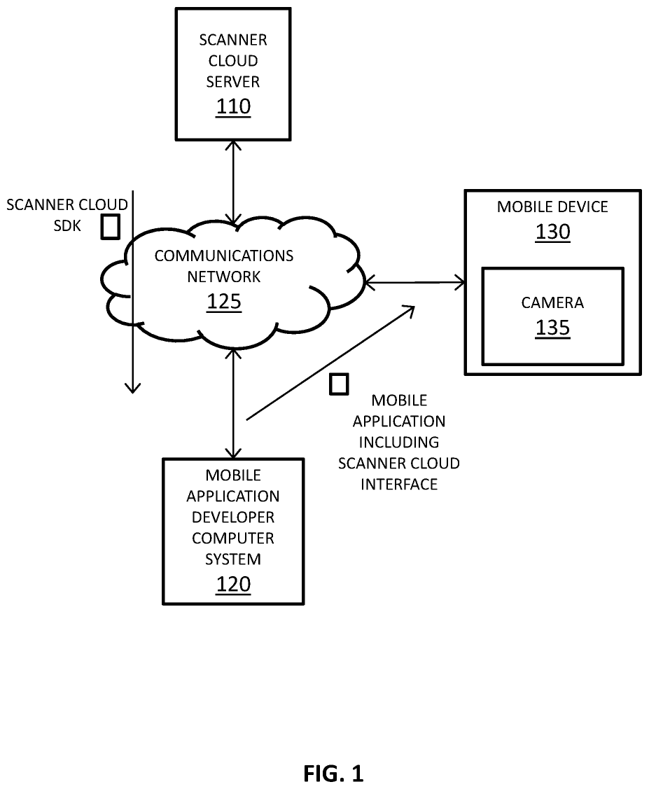

FIG. 1 is a block diagram of a scanner cloud system that illustrates the development and dissemination of a mobile application that incorporates a scanner cloud interface for facilitating the conversion of a physical payment and loyalty card into an electronic card. Scanner cloud server 110 stores a scanner software development kit (SDK), which is composed of a library of software functions and/or modules, which are referred to collectively as the scanner cloud interface, to control a camera 135 or other scanning device of a mobile device 130 and to control communications between the scanner cloud server 110 and the mobile device 130. The scanner cloud SDK is transferred to or downloaded by mobile application developer system 120 through communications network 125.

Mobile applications developed by retailers may have the same features, but may have different software structures and/or configurations for implementing those features. Thus, one software module or library function, which is applicable to one mobile application, may not be applicable to other mobile applications. The scanner cloud SDK provides an easy and generalized way for developers, who use different software structures to implement mobile applications, to implement functions for enabling communications between the scanner cloud server 110 and the mobile application, and enabling the scanner cloud server 110 to control software applications, hardware components, and functions of the mobile device.

For example, to scan a physical card using the camera 135, mobile application developers may add program code provided by the scanner cloud SDK to a mobile application to implement a scanner cloud interface, which allows the scanner cloud server to control the camera 135 via the mobile application's access to the camera. The scanner cloud server may cause the mobile application to perform functions such as adjusting the focus of the camera, adjusting the exposure time, selecting the right mode, and automatically setting options suitable for scanning an image. In this way, the mobile application developers do not have to develop sophisticated mobile applications to control functions of the mobile device, to convert physical cards to electronic cards, and to manage the electronic cards.

The communications network 125 may be the Internet, which connects to a mobile application market place, such as an “App Store” for iOS-based gadgets and a “Play Store” for Android-based gadgets. In some embodiments, the scanner cloud server 110 may post the scanner cloud SDK in the mobile application market place so that a mobile application developer can download the scanner cloud SDK from the mobile application market place. In other embodiments, the scanner cloud server 110 may post the scanner cloud SDK on a website that can be accessed through the communications network 125 so that mobile application developers may download the scanner cloud SDK from the website via the communications network 125.

After a mobile application developer completes the development of a new mobile application, which includes the scanner cloud interface, the mobile application developer may post the new mobile application to a website or a mobile application market place via the mobile application developer computer system 120. A user of the mobile device 130 may download the new mobile application from the website or the mobile application market place via the communications network 125 and install the new mobile application on the mobile device 130. The new mobile application includes the scanner cloud interface, through which the scanner cloud server 110 may control the camera 135.

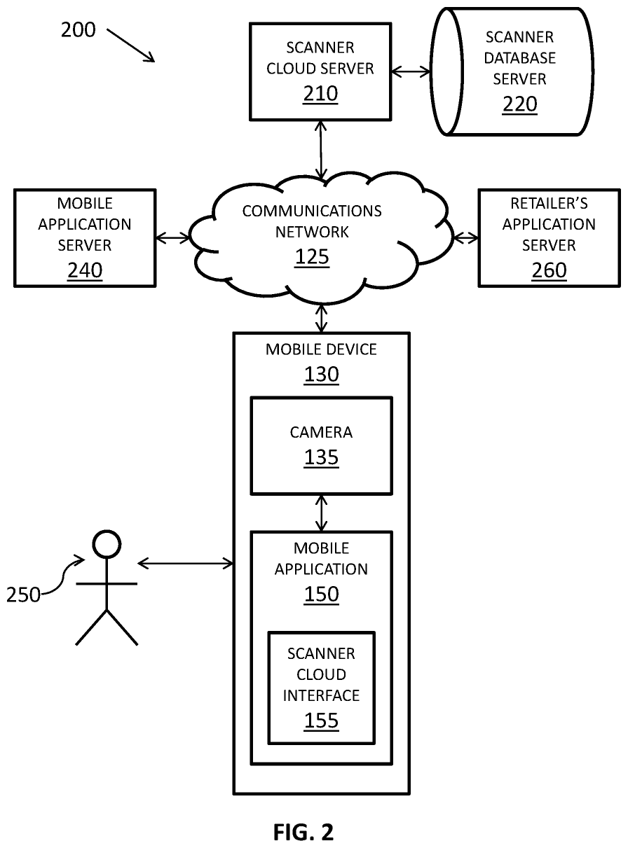

FIG. 2 illustrates a block diagram of scanner cloud system 200, which includes scanner cloud server 210, scanner database server 220, the communications network 125, and the mobile device 130. A user 250 operates the mobile device 130 to download and install the mobile application 150, which is equipped with scanner cloud interface 155. Retailer's application server 260 communicates with the mobile application 150 of the retailer. The scanner cloud interface 155 allows the scanner cloud server 210 to control the camera 135 or other component or functionality of the mobile device 130 to scan a physical card. The card may be any type of payment or loyalty card including closed system prepaid cards, semi-closed system prepaid cards, open system prepaid cards, gift cards, reward cards, payroll cards, rebate cards, cafeteria cards, travel cards, fare cards, membership cards, credit cards, charge cards, debit cards, automated teller machine (ATM) cards, fleet cards, cash cards, or cards presenting a code including a bar code or a quick response (QR) code.

The scanner cloud interface 155 uses the authorization information given to the mobile application 150 by the user of the mobile device 130 to permit the scanner cloud server 210 to use the software applications, hardware components, and other resources of the mobile device 130. For example, the scanner cloud interface 155 uses the authorization information of the mobile application 150 to permit the scanner cloud server 210 to control the camera 135 via the mobile application 150.

The scanner cloud interface 155 may add scanning and communications functions to the mobile application 150 as a plugin. The scanner cloud interface 155 may be represented by an icon on a screen of the mobile application 150. By selecting the icon, a user of the mobile application 150 can initiate the functions of the scanner cloud interface 155 so that the mobile application 150 can scan a payment or loyalty card to obtain an image of the payment or loyalty card and can transmit the image to the scanner cloud server 210. In embodiments, the icon may be a virtual button displayed on a screen of the mobile application 150. When the icon for the scanner cloud interface 155 is selected, the scanner cloud interface 155 may provide options to the mobile user, such as scan a card, manual entry of information relating to the card, and manual update of information relating to the card.

In embodiments, the scanner cloud interface 155 may control other resources or devices of the mobile device, such as, the speaker, the microphone, or network devices, using the authorizations granted by the user to the mobile application. When a user of the mobile application has an issue with the mobile application, the scanner cloud server 210 may use the scanner cloud interface 155 to remotely control the mobile device 130. For example, a person at the scanner cloud server 210 or remotely logged into the scanner cloud server 120 may communicate with the user of the mobile application to help the user fix an issue by using the speaker, the microphone, the display, or any combination of these devices of the mobile device 130. Or the scanner cloud server 210 may remotely control the mobile device or another application running on the mobile device through the scanner cloud interface 155 to set or update a setting in the mobile device to fix an issue.

The mobile application server 240 may include a market place for mobile applications. For example, developers of mobile applications may upload their mobile applications to the mobile application server 240 through the communications network 125. Then, users may download and install mobile applications from the mobile application server 240 to their mobile devices through the communications network 125.

The retailer's application server 260 may communicate with the mobile application 150 to provide user identification, dynamic content, product catalog information, shopping cart functionality, and/or user profile information through the communications network 125.

As described above, the scanner cloud server 210 may provide the scanner cloud SDK. When the mobile application 150 is equipped with the scanner cloud interface 155, which is based on the scanner cloud SDK, the scanner cloud server 210 is able to communicate with the mobile application 150 via the scanner cloud interface 155. In some embodiments, the scanner cloud server 210 may not initiate communications with the scanner cloud interface 155. Instead, the scanner cloud interface 155 may initiate communications with the scanner cloud server 210 through the communications network 125, when the user 250 desires to scan a physical card or retrieve an electronic card from the scanner cloud server 210.

The scanner cloud server 210 controls the camera 135 of the mobile device 130 via the scanner cloud interface 155 using the authorizations granted by the user to the mobile application 150, to scan the payment or loyalty card to obtain an image of the payment or loyalty card. The scanner cloud server 210 also receives the image from the mobile application 150 via the scanner cloud interface 155. The scanner cloud server 210 processes the image to extract information relating to the scanned card e.g., the scanner cloud server 210 optically recognizes information in the image. The scanner database server 220 then stores the image and the extracted information. The scanner database server 220 may be a part of the scanner cloud server 210 or may be a server separate from the scanner cloud server 210. The scanner database server 220 further stores any information relating to the image of the scanned payment or loyalty card.

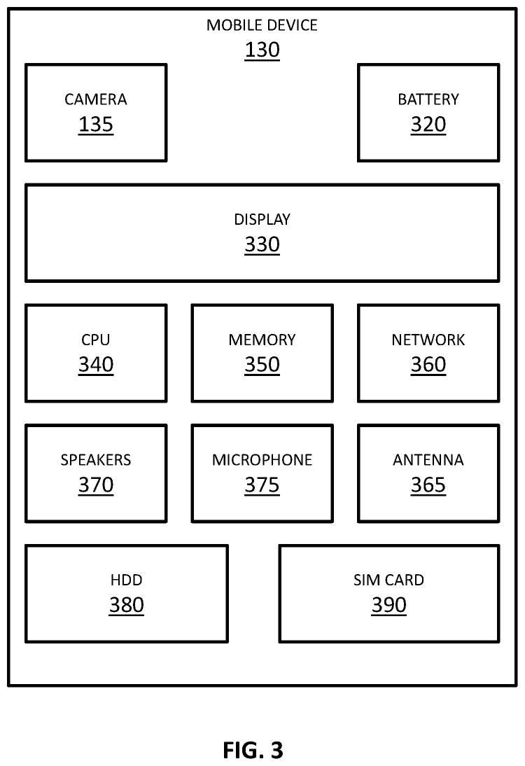

FIG. 3 is a block diagram of the mobile device 130 of FIG. 1. The mobile device 130 is a portable device, such as a smartphone, tablet, palm device, personal digital assistant, phablet, laptop, or any portable device. The mobile device 130 includes the camera 135, battery 320, display screen 330, processor 340, memory 350, a network interface 360, an antenna 365, speakers 370, microphone 375, a hard disk drive 380, and a SIM card 390. The camera 135 may be configured to take still images or moving images. The camera 135 may be used by other mobile applications which can capture still images or moving images, send the captured images to other people via multimedia messaging services, post the captured images to a social networking website, or edit the captured images.

The battery 320 provides electrical power to all the components of the mobile device 130. The battery 320 may be charged from another battery or a power outlet. When the voltage of the battery 320 reaches a threshold voltage or less, some hardware or mobile applications may be disabled to prevent loss of data. The scanner cloud interface 155 may check the battery level to determine whether or not the mobile application 150 should be closed.

The display 330 displays screens that are presented by the mobile application. The display 330 may be a touch-screen display that allows the user to press buttons or otherwise make selections in the mobile application.

The processor 340 may include any number of processors including one, two, four, six, eight, or any even number of processors. The processor 340 runs mobile applications residing in memory 350 of the mobile device 130 to cause the mobile device 130 to perform the functions defined by the mobile applications. The operating system and mobile applications are loaded into the memory 350 in the form of instructions, which are executed by the processor 340.

The memory 350 of the mobile device 130 may include a read-only memory (ROM), random access memory (RAM), flash memory, or universal serial bus (USB) memory. ROM is used to store instructions (e.g., batch processes) for the processor 340 to execute when the mobile device 130 is booted up or powered on. RAM is used to store data necessary to run the mobile applications. The flash or USB memory may be used for storing mobile applications and data.

The hard disk drive (HDD) 380 may be used together with the memory 350 to save applications and data. In some embodiments, a solid state disk (SSD) may replace the HDD 380.

The network interface 360 may be a network card for wired or wireless network communications with the communications network 125. The antenna 365 is also used with the network interface 360 so that the mobile device 130 can communicate through a wireless communication networks.

The speakers 370 and the microphone 375 may be used to vocally communicate with other communication devices. The microphone 375 may be also used together with the camera 135 to record moving images. The speakers 370 and the display screen 330 may be used to confirm whether the recorded moving images are the one to be recorded or whether still images are the ones the mobile user wants to scan, and whether the recorded moving images and/or the still images have sufficient resolutions having appropriate clarity and brightness.

The subscriber identity module (SIM) card 390 identifies the wireless communication company that provides wireless communication services to the mobile device 130 and holds personal information about the account holder, including the account holder's phone number, address book, text messages, and other data.

The components of the mobile device 130 shown in FIG. 3 are examples of components that may be found in the mobile device 130. The mobile device 130 may include other components including components that may be controlled by the scanner cloud interface to perform functions related to scanning cards or providing remote control, maintenance, and/or support functions.

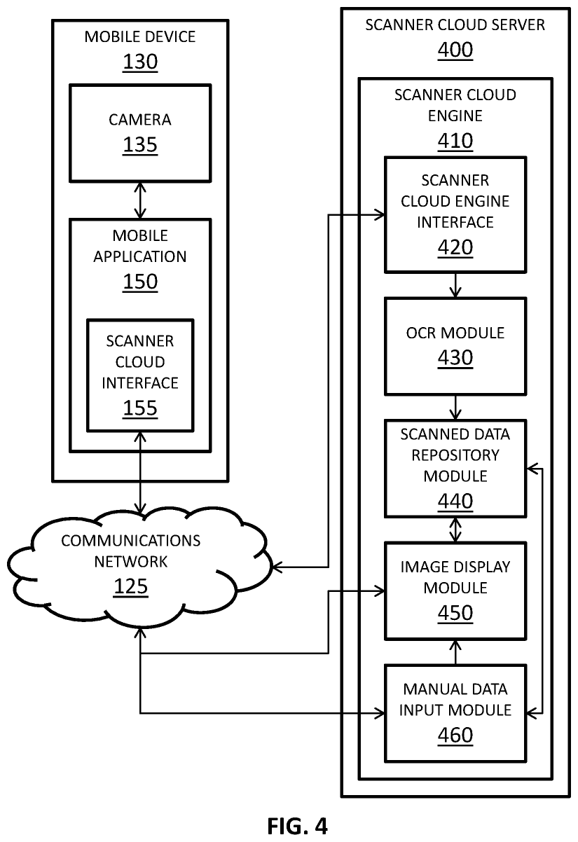

FIG. 4 is a block diagram of scanner cloud server 400 configured to communicate with the mobile device 130 via the communications network 125 to provide scanner cloud services to the mobile device 130. The scanner cloud server 400 includes scanner cloud engine 410, which includes scanner cloud engine interface 420, optical character recognition (OCR) module 430, scanned data repository module 440, image display module 450, and the manual data input module 460. The scanner cloud engine 410 communicates with the scanner cloud interface 155 through the communications network 125 using the scanner cloud engine interface 420.

In embodiments, the scanner cloud engine interface 420 waits for a request to scan a card from the scanner cloud interface 155 of the mobile application 150. Since the mobile application 150 receives authorization from the user to use resources of the mobile device 130 at the time the mobile application 150 is installed in the mobile device, the scanner cloud engine interface 420 can use the camera 135 or any other resource provided by the mobile device 130 via the scanner cloud interface 155 of the mobile application 150.

In embodiments, the scanner cloud interface 155 displays an option screen, in which the user is prompted to select one of the following options: scan a card, display an electronic card corresponding to a scanned card, manually enter information about a card, and manually update information about a card. When the scan option is selected by the user, the scanner cloud interface 155 sends a request for scanning a card to the scanner cloud server 400 through the communication network 125.

In response to the request to scan a card, the scanner cloud engine interface 420 sends a connection request to the scanner cloud interface 155, which establishes a connection between the scanner cloud engine interface 420 and the camera 135 or any other device of the mobile device 130 suitable for scanning a card. The scanner cloud engine interface 420 then controls the camera 135 to start sensing images and sending the sensed images to the display 330 of the mobile device 130. When a physical button of the mobile device 130 or a virtual button displayed on the screen display 330 is pressed, or when an image meeting specific criteria is visible within a specific focus area of the camera, the camera 135 captures a still image or moving images of the card so that the captured image includes all or a portion of the information on the face of the card, such as the card number and issuer's logo or name.

In embodiments, when a physical button of the mobile device 130 or a virtual button displayed on the display 330 is pressed, or when an image meeting specific criteria is visible within a specific focus area of the camera, the camera 135 captures an image of a bar code or QR code on the card and determines a numerical code associated with the image of the bar code or QR code. The scanner cloud engine interface 420 may send a message to a user of the mobile device 130 notifying the user to scan another side of the card or another card. For example, when the user requests scanning a payment or loyalty card and an image of the front side of the payment or loyalty card is scanned, the scanner cloud engine interface 420 may send a message to the user to scan the backside of the payment or loyalty card to obtain a backside image.

In embodiments, the scan request may be a request to capture an image of the front side or the back side of a card, to scan a bar code, to scan a QR code, to retrieve a radio frequency identification (RFID) code, or to use any other technique to obtain information provided by a physical payment or loyalty card, such as a reward card or a cash card.

The scanner cloud engine interface 420 receives the images of scanned cards from the mobile device 130 via the scanner cloud interface 155. The received images are then transmitted to the OCR module 430, which optically recognizes information in the images. The OCR module 430 recognizes characters, numerals, symbols, etc. and may identify the recognized information based on, for example, the location of the information on the payment or loyalty card. For example, the OCR module 430 may identify a card owner's name, an expiration date, a card number, a card issuer, a unique account number, serial numbers based on the recognized characters, numerals, symbols, etc. As a further example, when the terms “Amazon,” “Barnes & Noble,” “Chipotle,” “Sears,” or “American Express” are recognized, the OCR module 430 identifies the recognized information as the card issuer, or when the number “1234 5678 9012 3456” is recognized, the OCR module 430 identifies “1234 5678 9012 3456” as the card number.

The OCR module 430 may recognize a symbol in the image of the card, such as a logo of the card issuer, a bar code, or a QR code and decode the symbol. For example, a bar code may be decoded to obtain a series of numerals or characters or a QR code may be decoded to obtain information stored in the QR code.

The OCR module 430 also generates an electronic card based on the recognized information. The electronic card may be in the form of an image or a series of images assembled together. The electronic card may include a graphical code that is scannable by a scanning device at a retailer's store. For example, the electronic card may include a bar code or QR code that represents the card number specifically assigned to the scanned card, the card issuer's logo or trademark, and an amount of money credited to the card. The OCR 430 module then transmits the electronic card and the recognized information to the scanned data repository module 440.

The scanned data repository module 440 receives and stores the electronic card, the information recognized by the OCR module 430, information manually entered by the user, the image of the scanned card, or any combination of these items in an internal memory of the scanner cloud server 400. At least one of the electronic card, the recognized information, the manually-entered information, and the stored image may be retrieved and transmitted to the mobile application in response to a request transmitted from the mobile application via the scanner cloud interface 155. In embodiments, the scanned data repository module 440 may save the image of the scanned card, the electronic card, the manually-entered information, and the recognized information in the scanner database server 220 of FIG. 2, which is a separate server from the scanner cloud server 400.

When a mobile user of the mobile device 130 desires to use the electronic card, the user initiates the mobile application 150 and enters or selects commands in the mobile application 150 to transmit a request to display the electronic card to the scanner cloud server 400 via the scanner cloud interface 155. The image display module 450 receives the request through the communications network 125 and retrieves the electronic card, the stored information about the card, or both the electronic card and the stored information from the scanned data repository module 440. The image display module 450 transmits the electronic card, the stored information, or both the electronic card and the stored information to the mobile application 150 via the scanner cloud interface 155.

The mobile application 150 displays the electronic card and optionally displays the stored information on the display 330 of the mobile device 130. The user may then present the displayed electronic card to a cashier of a retailer's store, who may scan the electronic card using a suitable scanning device. In this way, the electronic card is used to buy products and/or services from the retailer.

In embodiments, the image display module 450 may transmit all or a portion of the stored information for a card to the scanner cloud interface 155, and the scanner cloud interface 155 may generate an electronic card based on the stored information. The mobile application 150 may then display the electronic card on the display 330 of the mobile device 130.

When the user of the mobile device 130 selects the manual entry option or the manual update option, the manual data input module 460 together with the scanner cloud interface 155 enables the user of the mobile device 130 to manually enter or edit the information associated with a card. When the user of the mobile device 130 selects the manual update option, the scanner cloud interface 155 transmits a request to manually update the information of the card to the manual data input module 460. The manual data input module 460 may receive the request and may cause the image display module 450 to retrieve the image of the card and stored information regarding the card from the scanned data repository module 440 and to transmit them to the mobile application 150 via scanner cloud interface 155 so that the mobile application 150 can display the image of the card and the stored information on the display 330 of the mobile device 130.

The image display module 450 may cause the display 330 to display a screen in which the image of the card is displayed on the top half of the screen and the stored information relating to the card is displayed on the bottom half of the screen. The screen may allow the user to manually update the displayed information relating to the card. The image of the card and the stored information regarding the card may be displayed in any format. For example, if the mobile device 130 is held in the portrait orientation, the image of the card and the information regarding the card may be displayed vertically, and if the mobile device 130 is held in the landscape orientation, the image of the card and the information regarding the card may be displayed horizontally.

The user can confirm that the displayed image is the card whose information the mobile user desires to update by comparing the displayed image with the corresponding physical payment or loyalty card. The updated information is then transmitted back to the manual data input module 460, which stores the updated information in the scanned data repository 440 so that the updated information replaces the stored information regarding the card.

In embodiments, the manual data input module 460 may send a confirmation message when there is any inconsistency between the updated information and the information previously stored in the scanned data repository module 440. The scanner cloud interface 155 may display the stored information and the manually updated information near the image so that the user can easily compare them and modify or confirm the accuracy of the manually updated information. The manual data input module 460 then replaces the information stored in the scanned data repository module 440 with the confirmed or modified information received from the scanner cloud interface 155.

When the mobile user selects the manual entry option, the manual data input module 460 may cause the mobile application 150 to display a screen including blank fields in which the user 250 may enter information regarding a card. After the user completes entering information in the blank fields, the mobile application 150 transmits the manually entered information to the manual data input module 460 via the scanner cloud interface 155. The manual data input module 460 then transmits the manually entered information to the scanned data repository module 440 to save it as the information regarding the card. The scanner cloud engine 410 may generate an electronic card based on the manually entered information and store the generated electronic card in the scanned data repository module 440. Alternatively, the scanner cloud engine may generate an electronic card based on the manually entered information regarding a scanned card and an image of the scanned card.

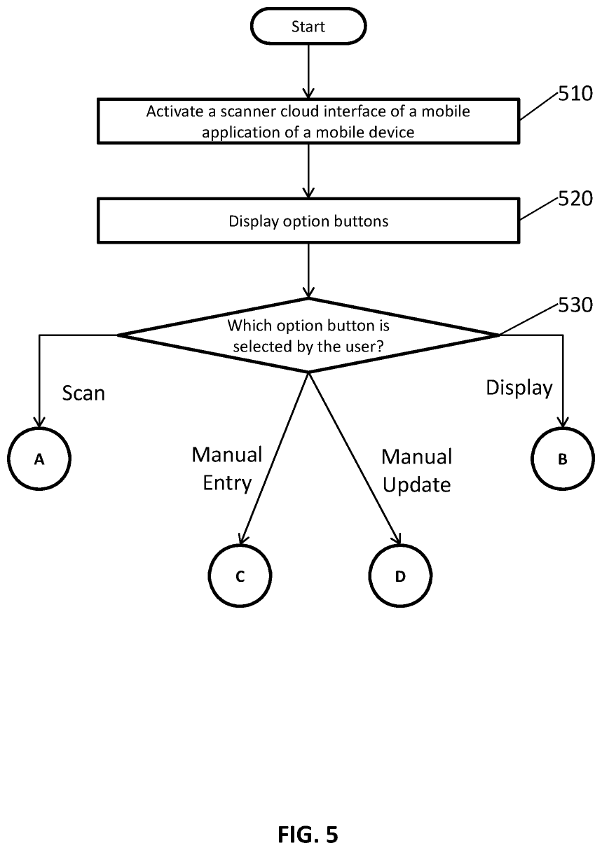

FIG. 5 illustrates a method performed by a mobile device to scan a card so that the card can be converted into an electronic card using the scanner cloud service. A mobile application incorporating a scanner cloud interface is installed on the mobile device. When the user of the mobile device starts the mobile application, the user can activate the scanner cloud interface, in step 510, by selecting an icon for the scanner cloud interface on a screen displayed by the mobile application on the mobile device.

When the icon for the scanner cloud interface is selected, the scanner cloud interface may display at least four options: scan a card, display an electronic card corresponding to a scanned card, manually enter information about a card, and manually update information about a card in step 520. In step 530, it is determined which option is selected by the user.

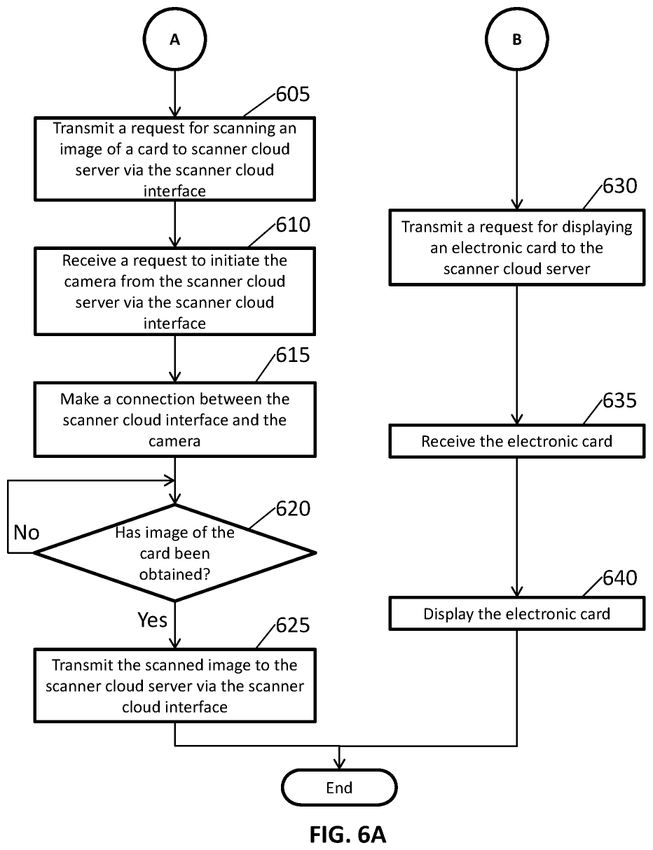

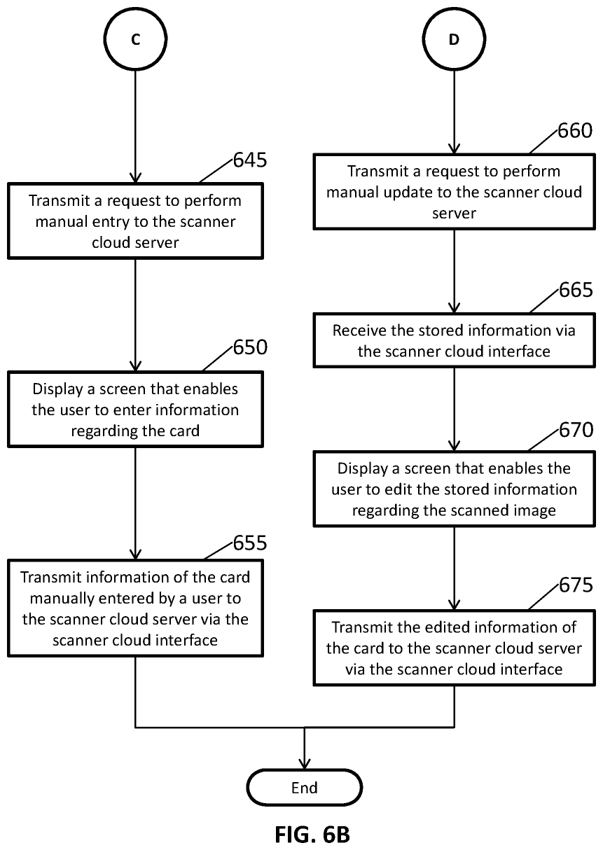

If the scan option is selected by the user in step 530 of FIG. 5, the process proceeds to point A shown in FIG. 6A, which illustrates processes performed by the mobile device. . In step 605, the scanner cloud interface transmits a request for scanning the card to the scanner cloud server in step 605. In step 610, the scanner cloud interface receives a connection request from the scanner cloud server in response to the request for scanning the card.

In step 615, the scanner cloud interface makes a connection between the camera of the mobile device and the scanner cloud server. The camera is controlled by the scanner cloud server to scan the card to obtain an image of the card. As described above, the card may be a closed loop card, an open loop card, a payment card, a loyalty card, pre-paid card, a reward card, a membership card, a cash card, and may include a code such as a bar code or a quick response (QR) code.

In step 620, it is determined whether the camera has scanned the card and obtained an image of the scanned card. When the camera has obtained the image, the scanner cloud interface transmits the image to the scanner cloud server in step 625.

In embodiments, when the image of the scanned card is transmitted to the scanner cloud server, the image is optically recognized and the recognized information is stored in the scanned data repository module. The scanner cloud server may then generate an electronic card based on the stored information and transmit the generated electronic card to the scanner cloud interface, which causes the mobile application to display the generated electronic card. The mobile application may save the generated electronic card in a secured local memory of the mobile device as a backup.

The local memory may be secured so that no mobile applications other than the mobile application incorporating the scanner cloud interface can access the electronic card. By storing the electronic card in local memory, the electronic card may be used in a situation where there is a disruption in communications between the mobile application and the scanner cloud server.

If the option to display an electronic card is selected by the user in step 530 of FIG. 5, the process proceeds to point B shown in FIG. 6A. In step 630, the mobile application transmits the request for displaying an electronic card to the scanner cloud server, which retrieves and transmits the electronic card and the information associated with the card. In step 635, the mobile application receives the electronic card and the associated information via the scanner cloud interface. In step 640, the mobile application displays the electronic card.

If the manual entry option is selected by the user in step 530 of FIG. 5, the process proceeds to point C shown in FIG. 6B. In step 645, the scanner cloud interface transmits the request for manual entry to the scanner cloud server. The scanner cloud interface displays a screen in step 650, which includes blank fields with captions, such as card number, card holder's name, expiration date, etc. relating to the card.

In other embodiments, the manual entry option may be selected to manually enter information which is not shown in the image of the scanned card but is related to the card. For example, the manually entered information may include the PIN number of the card, the zip code of the owner of the card, or the address of the owner. The user may not have to input data in all fields in a data input screen. The fields that require data may be identified by an asterisk positioned next to the labels indicating the data that should be input into the fields.

After the user finishes manually entering information in the fields of the data input screen presented by the scanner cloud interface of the mobile application, the scanner cloud interface transmits the information entered by the user to the scanner cloud server in step 655. The scanner cloud server may then generate an electronic card based on the manually-entered data.

If the manual update option is selected by the user in step 530 of FIG. 5, the process proceeds to point D shown in FIG. 6B. In step 660, the scanner cloud interface transmits the request for a manual update of information regarding a card to the scanner cloud server. In response to the request for the manual update, the scanner cloud server retrieves the image of the scanned card and/or the stored information associated with the image and transmits them to the scanner cloud interface. In step 665, the scanner cloud interface receives the image and/or the stored information associated with the image.

In step 670, the scanner cloud interface displays a screen showing the stored information associated with the image. In some embodiments, the screen may show the image and the stored information arranged next to each other in a vertical or horizontal orientation to enable the user to more easily compare the image of the scanned card with the stored information associated with the image. The user may then manually enter or correct the stored information if the information shown in the image of the scanned card is inconsistent with the stored information associated with the image. In step 675, the scanner cloud interface transmits the entered and/or corrected information to the scanner cloud server.

In embodiments, in step 670, the scanner cloud server may display a screen via the scanner cloud interface 155 asking for a passcode, which is to provide security to protect the information associated with the scanned card from unauthorized access such as identity theft.

In some embodiments, after receiving the manually updated information, the scanner cloud server may compare the manually updated information with the information stored in the scanner cloud server, which was previously optically recognized from the image of the card. If the manually updated information relating to a card is inconsistent with the information stored in the scanner cloud server, the scanner cloud interface may receive a warning message from the scanner cloud server. The scanner cloud interface may display a message to the user, such as “select or enter correct information,” while displaying both the manually updated information and the information associated with the card stored in the scanner cloud server. The scanner cloud interface may then transmit the information that is selected or entered by the user to the scanner cloud server. In this way, the integrity of the information associated with the card is maintained.

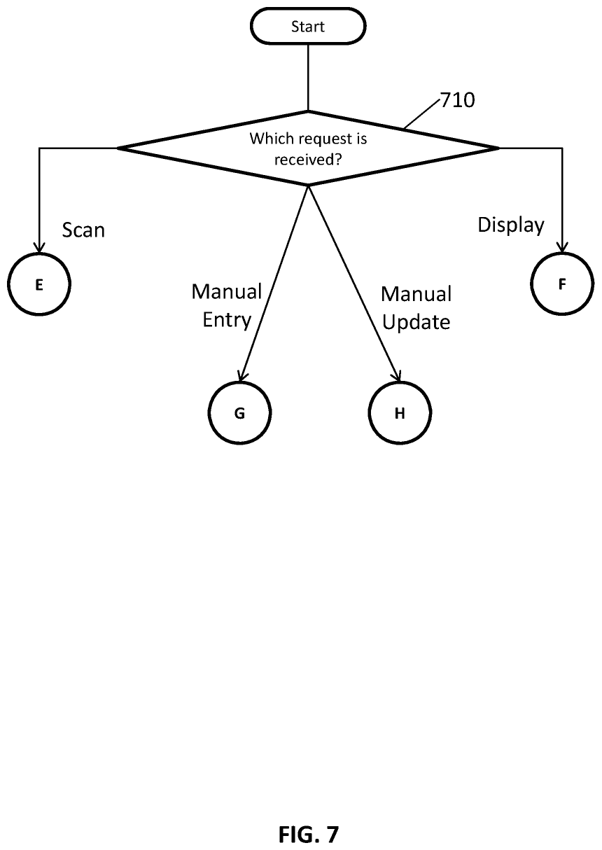

FIG. 7 illustrates a method performed by a scanner cloud server, which provides scanner services for mobile applications. When a user runs a mobile application incorporating a scanner cloud interface on a mobile device, the scanner cloud service may be initiated by the user. The scanner cloud interface of the mobile application sends a request for a service when the scanner cloud interface detects that an option is selected in the retailer's mobile application. The scanner cloud interface may provide at least four options to the user. In step 710, the scanner cloud server determines via the scanner cloud interface which option has been selected by the user.

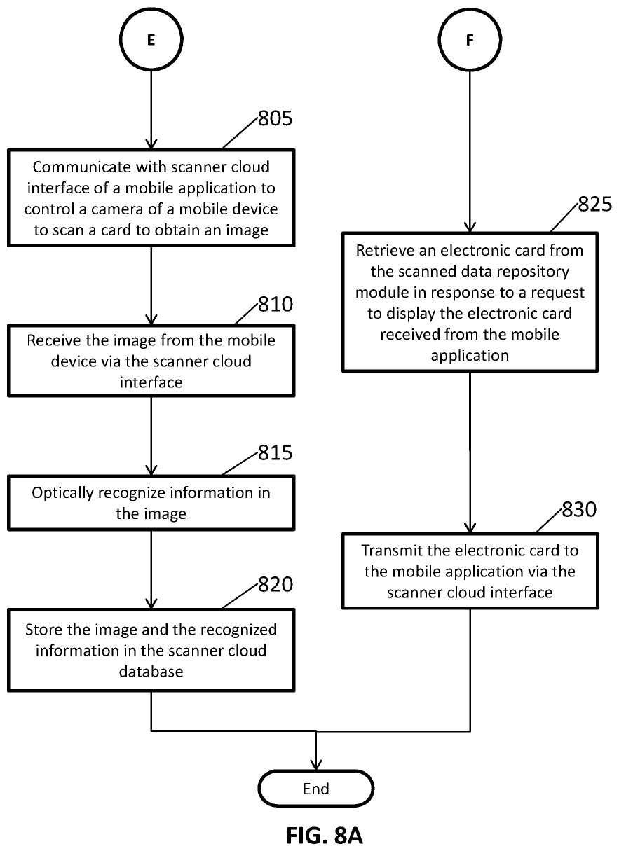

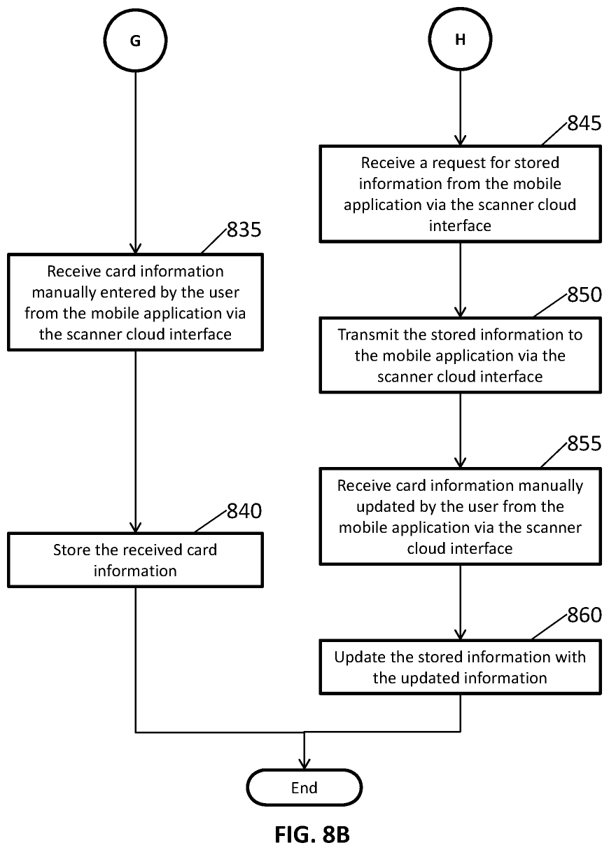

If the request for scanning a card is selected by the user, the process of FIG. 7 proceeds to point E of FIG. 8A, which illustrates additional processes performed by the scanner cloud server. Those processes may be performed by the scanner cloud server in conjunction with the processes performed by the mobile device, which are illustrated in FIG. 6A.

In step 805 of FIG. 8A, the scanner cloud server starts communicating with the scanner cloud interface. In response to selecting the scanning option, the scanner cloud server sends a connection request to the scanner cloud interface. A connection between the camera of the mobile device and the scanner cloud server is established using the permissions granted by the user through the mobile application. The scanner cloud server then controls the camera to scan the card to obtain an image of the card. The camera may scan a portion of the card, such as a bar code, a QR code, or a symbol. The scanner cloud interface transmits the image of the scanned card to the scanner cloud server. In some embodiments, the scanner cloud interface stores the image of the scanned card in memory of the mobile device in a case when there is an interruption in communications between the scanner cloud interface and the scanner cloud server. This locally stored image may be transmitted when the scanner cloud interface resumes communications with the scanner cloud server.

In step 810, the scanner cloud server receives the image of the scanned card from the mobile device via the scanner cloud interface. The OCR module of the scanner cloud server processes the image to optically recognize information in the image in step 815. The recognized information may include alphanumeric characters, symbols, or graphics, such as the card number. Also, in step 815, the OCR module converts the recognized information into a scannable image, i.e., an electronic card. In step 820, the electronic card, the image of the card, and the information recognized in the image are stored in the scanned data repository module of the scanner cloud server.

If the request for displaying an electronic card is selected by the user, the process of FIG. 7 proceeds to point F of FIG. 8A. In step 825, the scanner cloud server retrieves an electronic card from the scanned data repository module in response to a request from the mobile application to display the electronic card. In step 830, the scanner cloud server transmits the electronic card to the mobile application via the scanner cloud interface so that it can be displayed to the user. In embodiments, the scanner cloud server may transmit available electronic cards to the mobile application via the scanner cloud interface so that the mobile application can present available electronic card to the user for selection by the user.

In embodiments, the electronic card may include a scannable image (e.g., a bar code, QR code, etc.), a card issuer's symbol or logo, and information or data relating to the card (e.g., the current value of the card, the expiration date, fees associated with the card, etc.).

If the request for manual entry of information regarding a card is selected by the user in step 710 of FIG. 7, the process proceeds to point G of FIG. 8B, which illustrates additional processes performed by the scanner cloud server. Those processes may be performed by the scanner cloud server in conjunction with the processes performed by the mobile device illustrated in FIG. 8B.

In step 835 of FIG. 8B, the scanner cloud interface receives information regarding a physical card, which is manually entered by the user via a graphical user interface of the mobile application, from the mobile application via the scanner cloud interface. For example, the user may manually enter a retailer name and a card number into a field of the graphical user interface of the mobile application and this information may be transmitted by the mobile application to the scanner cloud server via the scanner cloud interface. In step 840, the received information is stored in local memory of the scanner cloud server or a separate database server. The scanner cloud server may also generate an electronic card based on the received information and store the generated electronic card in the scanner database server 220.

If the request for manual update of information regarding a card is selected by the user in step 710 of FIG. 7, the process proceeds to point H of FIG. 8B. In step 845, the scanner cloud server receives a request for the information stored in the scanner cloud database server from the mobile application via the scanner cloud interface. In response to the request, the scanner cloud server retrieves the information stored in the scanner cloud database server and transmits it to the mobile application via the scanner cloud interface in step 850.

The scanner cloud interface displays a screen showing the stored information on the display 330 of the mobile device 130. In one embodiment, the scanner cloud server also transmits the image of the scanned card to the scanner cloud interface so that the scanner cloud interface can cause the display to display the image of the card and the corresponding information at the same time.

The user may correct inconsistencies between the image of the scanned card and the stored information or make any other type of update, e.g., enter a new balance for a card. In step 855, the scanner cloud server receives the corrected or updated information from the mobile application via the scanner cloud interface. The scanner cloud server updates the stored information with the newly received information that is corrected or updated by the user of the mobile device in step 860. In some embodiments, the scanner cloud server may not transmit information stored in the scanner database server to the mobile application (e.g., the scanner could server may not perform steps 845 and 850), but may simply receive new information from the mobile application and update the information stored in the scanner database server based on the received new information (e.g., the scanner cloud server may only perform steps 855 and 860).

In other embodiments, when the manually updated information is inconsistent with the stored information, the scanner cloud server may transmit a warning message to the scanner cloud interface. In response to the confirmation message, the scanner cloud interface displays the inconsistent information to the user who may be prompted to select or enter the correct information. The scanner cloud server may receive the correct information selected or entered by the user and may store the newly received information as the information associated with the image of the scanned card.

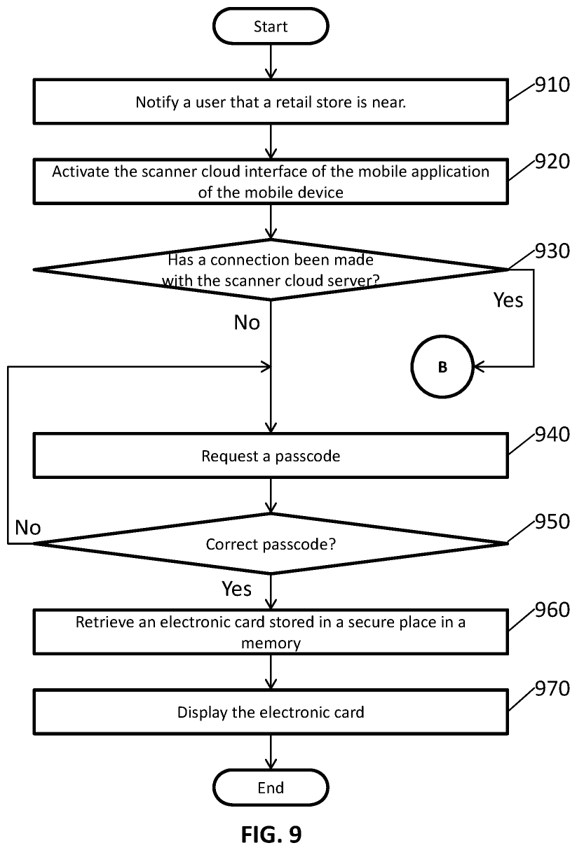

FIG. 9 illustrates a method performed by a mobile device to use an electronic card stored in a scanner cloud server. Generally, mobile devices are equipped with global positioning system (GPS) so that the location of a mobile device can be tracked. When the mobile device comes near to a retailer's store, the mobile application, which incorporates a scanner cloud interface, may be configured to search for a previously saved electronic card of the retailer. If the mobile application finds a previously saved electronic card of the retailer, the mobile application notifies a user of the mobile device that the retailer's store is near to the user in step 910. The user may be notified using any number of the functions available on the mobile device. For example, the mobile application may send a command to cause the mobile device to vibrate, to make a sound, to illuminate a light, and/or to display a screen including a predetermined image or message.

In step 920, the user activates the scanner cloud interface by selecting an icon in the notification screen or by selecting an icon in a screen of the mobile application that identifies the card of the retailer. Once the scanner cloud interface is activated, the mobile application determines whether the scanner cloud interface is connected with the scanner cloud server in step 930. When it is determined that there is a connection, the mobile application sends a request to display the electronic card to the scanner cloud server, receives the electronic card, and displays the electronic card according to the steps of sub-process B of FIG. 6A

When it is determined that there is no connection between the scanner cloud server and the scanner cloud interface in step 930, the mobile application may use the electronic card, which is stored in a secured place in the memory of the mobile device. In step 940, the mobile application displays a screen asking for a passcode. The passcode may be a numeric or alphanumeric passcode.

In step 950, it is determined whether the passcode entered by the user is the correct passcode for that user. When it is determined that the passcode is not correct, the method continues asking for the correct passcode until the user enters the correct passcode. In embodiments, the mobile application may only allow a predetermined number of retries. If the user enters the wrong passcode more than the predetermined number retries, the user may not be able to retrieve the electronic card stored in the secured place.

When it is determined that the correct passcode is entered, the mobile application retrieves the electronic card from the secured memory in step 960 and displays the electronic card in step 970.

Since other modifications and changes may be made to fit particular operating requirements and environments, it is to be understood by one skilled in the art that the present disclosure is not limited to the examples described in the present disclosure and may cover various other changes and modifications which do not depart from the spirit or scope of this disclosure.

What is claimed is:

1. A method comprising:
receiving, by a scanner cloud application, a request for scanning a card from a mobile application installed on a mobile device, via a scanner cloud interface plugin in the mobile application;
receiving, by the scanner cloud application, from the scanner cloud interface plugin, a permission to connect to a scanning function of the mobile device, the scanner cloud interface plugin generating the permission based on an authorization granted to the mobile application by a user of the mobile device;
controlling, by the scanner cloud application, the scanning function via the scanner cloud interface plugin to scan the card to obtain an image;
receiving, by the scanner cloud application, the image of the scanned card from the mobile application via the scanner cloud interface plugin; and
optically recognizing, by the scanner cloud application, information in the image of the scanned card.

2. The method according to claim 1, further comprising:
storing, by the scanner cloud application, the recognized information.

3. The method according to claim 1, further comprising:
generating, by the scanner cloud application, an electronic card based on the optically recognized information; and
transmitting, by the scanner cloud application, the electronic card to the mobile application via the scanner cloud interface plugin in response to a request for the electronic card from the mobile application.

4. The method according to claim 1, further comprising:
receiving information input by a user to the mobile application; and
generating an electronic card based on the optically recognized information and the information input by the user.

5. The method according to claim 4, further comprising transmitting at least one of the recognized information and the information input by the user to the mobile application via the scanner cloud interface plugin in response to a request from the mobile application to edit at least one of the recognized information and the information input by the user.

6. The method according to claim 4, further comprising:
receiving new information input by a user from the mobile application via the scanner cloud interface plugin; and
updating at least one of the recognized information and information previously input by the user with the new information.

7. The method according to claim 1, further comprising:
receiving information input by a user from the mobile application via the scanner interface; and
generating an electronic card based on the information input by the user.

8. The method according to claim 1, further comprising:
generating, by the scanner cloud application, an electronic card based on the optically recognized information; and
receiving, by the mobile application, an electronic card from the scanner cloud application via the scanner cloud interface plugin.

9. The method according to claim 8, further comprising:
determining, by the mobile application, whether the scanner cloud interface plugin is in communication with the scanner cloud application; and
retrieving, by the mobile application, the electronic card, when the user requests the electronic card and when it is determined that the scanner cloud interface plugin is not in communication with the scanner cloud application.

10. The method according to claim 1, further comprising:
storing, by the mobile application, the image in memory of the mobile device, when it is determined that the scanner cloud interface plugin is not in communication with the scanner cloud application; and
transmitting, by the mobile application, the stored image to the scanner cloud application, when it is determined that the scanner cloud interface plugin is in communication with the scanner cloud application.

11. A method performed by a mobile device on which a mobile application is installed, the mobile application incorporating a scanner cloud interface plugin for communicating with a scanner cloud server, the method comprising:
activating the scanner cloud interface plugin upon user selection of the scanner cloud interface plugin in the mobile application;
detecting user selection of a scanning option in the mobile application to scan a card;
transmitting a message that the user has selected the scanning option to the scanner cloud server via the cloud scanner interface;
receiving commands from the scanner cloud server via the scanner cloud interface plugin to scan the card;
scanning the card to obtain an image of the card; and
transmitting the image of the scanned card to the scanner cloud server via the scanner cloud interface plugin.

12. The method according to claim 11, further comprising:
prompting the user to select an option of the scanner cloud interface plugin;
detecting selection by the user of a display option for displaying the electronic card;
prompting the user to select an electronic card;
detecting selection by the user of an electronic card;
sending a request for the electronic card to the scanner cloud server via the scanner cloud interface plugin;
receiving the electronic card from the scanner cloud server via the scanner cloud interface plugin; and
displaying the electronic card.

13. The method according to claim 11, wherein receiving the electronic card includes receiving graphical images and data, and
wherein displaying the electronic card includes assembling the graphical images and data into an electronic card image.

14. The method according to claim 11, further comprising:
prompting the user to select an option of the scanner cloud interface plugin; and
determining whether a manual update option or a manual entry option is selected.

15. The method according to claim 14, wherein, when it is determined that the manual update option is selected, the method further comprises:
prompting the user to select an electronic card;
detecting selection by the user of an electronic card;
transmitting a request for information relating to the electronic card to the scanner cloud server via the scanner cloud interface plugin;
receiving information relating to the electronic card from the scanner cloud server via the scanner cloud interface plugin;
displaying an update screen allowing the user to update the information relating to the electronic card; and
transmitting updated information to the scanner cloud server via the scanner cloud interface plugin.

16. The method according to claim 14, wherein, when it is determined that the manual entry option is selected, the method further comprises:
prompting the user to enter information relating to a payment or loyalty card; and
transmitting information entered by a user to the scanner cloud server via the scanner cloud interface plugin.

17. The method according to claim 14, wherein the information entered by the user is related to a barcode, a QR code, or is information which is shown or not shown on a payment or loyalty card.

18. A scanner cloud system that provides scanning as a service through a network to a mobile application installed on a mobile device, the scanner cloud system comprising:
a scanner cloud engine configured to communicate with the mobile application via a scanner cloud interface plugin of the mobile application to control scanning on the mobile device to scan a card to obtain an image;
a recognition module configured to recognize information in the image of the scanned card;
an input module configured to receive information input by a user from the mobile application via the scanner cloud interface plugin; and
an image display module configured to generate an electronic card based on at least one of the recognized information and the input information, and transmit the electronic card to the mobile application via the scanner cloud interface plugin in response to a request to display the electronic card received from the mobile application via the scanner cloud interface plugin.

19. The scanner cloud system according to claim 18, wherein the input module is further configured to update at least one of the recognized information and the input information previously received from the mobile application with new input information received from the mobile application.

20. The scanner cloud system according to claim 18, wherein the scanner cloud engine is further configured to control or manage resources of the mobile device by communicating with the mobile application via the scanner cloud interface plugin.
